(19) United States
(12) Patent Application Publication
(10) Pub. No.: US 2026/0089321 A1
(43) Pub. Date: Mar. 26, 2026

(54) WEIGHTED FILTERING FOR PICTURE ENHANCEMENT IN VIDEO CODING

(71) Applicant: GUANGDONG OPPO MOBILE TELECOMMUNICATIONS CORP., LTD., Dongguan (CN)

(72) Inventors: Tim CLASSEN, Dongguan (CN); Mathias WIEN, Dongguan (CN)

(73) Assignee: GUANGDONG OPPO MOBILE TELECOMMUNICATIONS CORP., LTD., Dongguan (CN)

(21) Appl. No.: 19/409,471

(22) Filed: Dec. 4, 2025

Related U.S. Application Data
(63) Continuation of application No. PCT/CN2023/105957, filed on Jul. 5, 2023.

(51) Int. Cl. H04N 19/117; H04N 19/184; H04N 19/186

(52) U.S. Cl. CPC H04N 19/117; H04N 19/184; H04N 19/186

(57) ABSTRACT

A method of processing video data, performed by a decoder, is provided. The method includes decoding a bitstream to obtain video data and coding information; obtaining a picture based on the video data; determining a weighting map using a weighting map function, the weighting map comprising a plurality of weights mapped to respective spatial locations of the picture, wherein the picture and/or coding information are used as inputs to the weighing map function; determining a filter; and applying the weighting map and the filter to the picture to obtain a filtered picture.

### CROSS-REFERENCE TO RELATED APPLICATION

The present application is a continuation of International Application No. PCT/CN2023/105957 filed on Jul. 5, 2023, the disclosure of which is hereby incorporated by reference in its entirety.

### BACKGROUND

Current video coding schemes such as H.265/HEVC and H.266/VVC apply so called in-loop filters to the encoded video content inside the coding loop. These filters aim at concealing certain types of artifacts like blocking or at increasing the objective quality. This processing step can improve the quality of the picture not only for its output. In particular, the filtered pictures are often then used to predict next pictures in most coding setups (e.g. inter prediction can be performed). Therefore, the quality of subsequently coded pictures can also be increased.

Filtering the video in order to increase the quality of the picture requires that there are statistical dependencies that can be exploited by the filtering system. In general, it makes sense to apply in-loop filtering if the quality improvement achieved by the filtering outweighs the signaling costs at this rate distortion (RD)-point. Moreover, the computation time needs to be acceptable.

In a number of video coding systems, a series of filters are applied which address different types of coding errors. For example, there is a de-blocking filter which can applied at block borders to decrease blocking artifacts. Next, there can be a sample adaptive offset (SAO) filter which is mainly designed to reduce ringing or blurring artifacts. Lastly, an adaptive loop filter (ALF) could be used for an objective quality enhancement. Note that this is only a small excerpt and meant as an overview of different applications and types of loop filters.

Most of these filters deal only with a limited range of coding errors. Moreover, there are no filters implemented in VVC/H.266 which explicitly target the problem of blurred picture content. However, blurring does happen, due to the quantization or removal of high-frequency components. Usually, linear filters are insufficient to recover blurred content due to problems of overshoot and ringing. Moreover, noise amplification is a problem. Linear filtering approaches like the adaptive loop filter attempt to deal with that problem by introducing a set of classes for which different filters are applied. However, this increases coding costs.

### SUMMARY

The present application relates to the field of computer vision, in particular to the topic of video processing and video coding, more particularly to a method of processing video data performed by an decoder, and a method of processing video data performed by an encoder, and a computer-readable medium.

Embodiments of the present application provide a method of processing video data performed by an decoder, and a method of processing video data performed by an encoder, and a computer-readable medium.

According to a first aspect, a method of processing video data, performed by a decoder, the method comprising: decoding a bitstream to obtain video data and coding information; obtaining a picture based on the video data; determining a weighting map using a weighting map function, the weighting map comprising a plurality of weights mapped to respective spatial locations of the picture, wherein the picture and/or coding information are used as inputs to the weighing map function; determining a filter; and applying the weighting map and the filter to the picture to obtain a filtered picture, such that the filter is applied with different weights to different spatial locations of the picture.

In some embodiments, the coding information comprises signalled weighting map function parameters, and determining the weighting map using the weighting map function comprises: applying the signalled weighting map function parameters as parameters of the weighting map function; and providing the picture as an input to the weighting map function.

In some embodiments, the coding information comprises signalled filter function parameters, and determining the filter comprises: applying the signalled filter function parameters as parameters of the filter.

In some embodiments, applying the weighting map and the filter to the picture to obtain the filtered picture takes place within the coding loop or as a post-loop step.

In some embodiments, the coding loop is a H.266/VVC coding loop.

In some embodiments, the step of applying the weighting map and the filter to the picture to obtain the filtered picture is integrated into an adaptive loop filter and is applied to derived partitions.

In some embodiments, the bitstream is rate distortion (RD)-optimized based on an estimated signaling rate and distortion after applying the weighting map and the filter to the picture.

In some embodiments, the picture comprises a luma-channel, a chroma channel or both, and wherein the weighting map and the filter are applied to the luma-channel, the chroma channel or both.

In some embodiments, which of the luma-channel and the chroma channel the weighting map and the filter are to be applied to is predetermined, signaled in the bitstream, or inferred from the picture's content.

In some embodiments, the method further comprises partitioning in the picture into a plurality of partitions, wherein the weighting map and the filter are applied to one or multiple partitions of the picture, wherein the partitions are signaled in the coding information.

In some embodiments, the partitions being signaled in the coding information comprises a signaled block-partitioning, signaled region partitioning criteria or a binarized weighting map function in the coding information.

In some embodiments, the method further comprises applying multiple filters to a same picture partition.

In some embodiments, the filter is configured to address the problem of ringing artifacts, blurring and/or blocking artifacts in the picture.

In some embodiments, determining the weighting map using a weighting map function comprises: applying a weighting map function which outputs a scalar weighting map, with the scalar being binary, integer or floating-point.

In some embodiments, determining the weighting map using a weighting map function comprises: applying a weighting map function which outputs a multi-dimensional weighting map, with each element being binary, integer or floating-point.

In some embodiments, the weighting map information for one or more channels of the obtained picture is computed using information from one or more channels of the obtained picture as input.

In some embodiments, a set of weighting map functions are predefined, and wherein the coding information signals the weighting map function to be used.

In some embodiments, the weighting map functions are parametric.

In some embodiments, the coding information signals a plurality of weighting map functions, wherein determining the weighting map using the weighting map function comprises determining a plurality of weighting maps using the plurality of weighting map functions, and wherein applying the weighting map and the filter comprises applying one or more filters for each signaled weighting map.

In some embodiments, the filtering function and parameters of the filter are signaled in the coding information, pre-defined, inferred from the content of the video, or inferred from the coding information.

In some embodiments, the filter is a linear filter, and a shape of the filter is indicated in the bitstream or predefined.

In some embodiments, the linear filter is optimized by a least-squares optimization or RD-optimized.

In some embodiments, the linear filter is a parametric linear filter.

In some embodiments, the parametric linear filter is RD-optimized with regards to a minimal error at the output, derived by least squares optimization, iterative search, or exhaustive search.

In some embodiments, the filter is a bilateral filter.

In some embodiments, determining the filter comprises determining a plurality of filters, wherein applying the weighting map and the filter to the picture comprises applying each filter of the plurality of filters at a location signaled in the bitstream or indicated in the weighting map.

In some embodiments, a parametric weighting map is optimised together with the filtering function.

In some embodiments, applying the weighting map and the filter to the picture comprises applying one or more filters to partitions of the picture based on a block-partitioning signaled in the coding information.

In some embodiments, applying the weighting map and the filter to the picture comprises applying one or more filters to partitions of the picture based on derived region partitioning criteria.

In some embodiments, the filter and weighting map calculation parameters are encoded by a quantization, prediction, and/or an entropy coding scheme.

According to a second aspect, there is provided a method of processing video data, performed by an encoder, the method comprising: obtaining original video data; compressing the original video data into compressed video data; obtaining a picture based on the compressed video data; determining a weighting map using a weighting map function, the weighting map comprising a plurality of weights mapped to respective spatial locations of the picture, wherein the picture is used as an input to the weighing map function; determining a filter to be applied to the picture with the weighting map wherein the filter is configured to be applied, with the weighting map, to the picture to obtain a filtered picture, such that the filter is applied with different weights to different spatial locations of the picture, at the decoder; and encoding the compressed video data and coding information into a bitstream, the coding information comprising information on the weighting map function and/or filter to be used at a decoder.

In some embodiments, the coding information comprises signalled weighting map function parameters configured to allow the decoder to determine the weighting map using the weighting map function by: applying the signalled weighting map function parameters as parameters of the weighting map function; and providing the picture as an input to the weighting map function.

In some embodiments, the coding information comprises signalled filter function parameters configured to allow the decoder to determine the filter by: applying the signalled filter function parameters as parameters of the filter.

In some embodiments, the weighting map and the filter are configured to be applied to the picture to obtain the filtered picture as a step within the coding loop or as a post-loop step.

In some embodiments, the coding loop is a H.266/VVC coding loop.

In some embodiments, the weighting map and the filter are configured to be integrated into an adaptive loop filter and applied to derived partitions of the picture to obtain the filtered picture.

In some embodiments, the bitstream is rate distortion (RD)-optimized based on an estimated signaling rate and distortion after applying the weighting map and the filter to the picture.

In some embodiments, the picture comprises a luma-channel, a chroma channel or both, and the weighting map and the filter are configured to be applied to the luma-channel, the chroma channel or both.

In some embodiments, which of the luma-channel and the chroma channel the weighting map and the filter are to be applied to is predetermined, signaled in the coding information, or configured to be inferred from the picture's content.

In some embodiments, the method further comprises partitioning in the picture into a plurality of partitions, wherein the weighting map and the filter are configured to be applied to one or multiple partitions of the picture, wherein the partitions are signaled in the coding information.

In some embodiments, the partitions being signaled in the coding information comprises a signaled block-partitioning, signaled region partitioning criteria or a binarized weighting map function in the coding information.

In some embodiments, the method further comprises determining a plurality of filters to be applied to a same picture partition.

In some embodiments, the filter is configured to address the problem of ringing artifacts, blurring and/or blocking artifacts in the picture.

In some embodiments, determining the weighting map using a weighting map function comprises: applying a weighting map function which outputs a scalar weighting map, with the scalar being binary, integer or floating-point.

In some embodiments, determining the weighting map using a weighting map function comprises: applying a weighting map function which outputs a multi-dimensional weighting map, with each element being binary, integer or floating-point.

In some embodiments, the weighting map information for one or more channels of the obtained picture is computed using information from one or more channels of the obtained picture as input.

In some embodiments, a set of weighting map functions are predefined, and the coding information signals the weighting map function to be used.

In some embodiments, the weighting map functions are parametric.

In some embodiments, the coding information signals a plurality of weighting map functions, wherein determining the weighting map using the weighting map function comprises determining a plurality of weighting maps using the plurality of weighting map functions, and wherein one or more filters are configured to be applied for each signaled weighted map.

In some embodiments, the filtering function and parameters of the filter are signaled in the coding information, pre-defined, configured to be inferred from the content of the video, or configured to be inferred from the coding information.

In some embodiments, the filter is a linear filter, and a shape of the filter is indicated in the bitstream or predefined.

In some embodiments, the linear filter is optimized by a least-squares optimization or RD-optimized.

In some embodiments, the linear filter is a parametric linear filter.

In some embodiments, the parametric linear filter is RD-optimized with regards to a minimal error at the output, derived by least squares optimization, iterative search, or exhaustive search.

In some embodiments, the filter is a bilateral filter.

In some embodiments, determining the filter comprises determining a plurality of filters, wherein each filter of the plurality of filters is configured to be applied at a location signaled in the bitstream or indicated in the weighting map.

In some embodiments, a parametric weighting map is optimised together with the filtering function.

In some embodiments, one or more filters are configured to be applied to partitions of the picture based on a block-partitioning signaled in the coding information.

In some embodiments, one or more filters are configured to be applied to partitions of the picture based on derived region partitioning criteria.

In some embodiments, the filter and weighting map calculation parameters are encoded by a quantization, prediction, and/or an entropy coding scheme.

According to a fifth aspect, there is provided a non-transitory computer-readable storage medium, having a computer program and a bitstream stored thereon, wherein the computer program, when executed by a processor, enables the processor to perform any of the methods of the second aspect to generate the bitstream.

These and other aspects of the present application may become more readily apparent from the following description of the embodiments.

### BRIEF DESCRIPTION OF THE DRAWINGS

Embodiments will now be described, by way of example only, with reference to the accompanying drawings, in which:

FIG. 1 shows a flowchart of the operations of a decoder according to an embodiment;

FIG. 2 shows a flowchart of the operations of an encoder according to an embodiment;

FIG. 3 shows a block diagram illustrating example operations in an embodiment;

FIG. 4 shows graph comparing a plurality of filtering schemes against a ground truth signal.

FIG. 5 shows a block diagram illustrating example operations in an embodiment;

FIG. 6 shows a schematic illustration of a decoder according to various embodiments; and

FIG. 7 shows a schematic illustration of an encoder according to various embodiments.

### DETAILED DESCRIPTION

Technical solutions in the embodiments of the present application will be described clearly and completely below with reference to the accompanying drawings.

These technical solutions may be applied to a H.265/HEVC or H.266/VVC video coding system (e.g. in an in-loop process where other filters such as an adaptive loop filter (ALF) and sample adaptive offset filter (SAO) are currently applied in such coding processes). However, it is to be understood that these technical solutions may applied in any other video coding system that involves video compression. Furthermore, while these principles are primarily illustrated with reference to video processing, they are also applicable to other data forms, including image processing or even audio processing.

A “video” in the embodiments refers to one or more pictures. In other words, a video can include one picture or a plurality of pictures. A picture may also be referred to as an “image”.

An “encoder” is a device capable of encoding data into a bitstream, while a “decoder” is a device capable of decoding the bitstream in order to obtain the encoded data, or an approximation of the encoded data. A “bitstream”comprises a sequence of bits.

“Intra-prediction” and “inter-prediction” are two prediction operations that can be used within the HEVC and VVC frameworks for a decoder to process a received bitstream in order to obtain the original signal. In the embodiments, “original signal” or “original video” is used to refer to the data prior to encoding at the encoder. A reference sample in the embodiments may refer to spatially and/or temporally spaced picture data used for the prediction of a picture (or region of a picture). Intra and inter-prediction operations are also used at the encoder to make rate-distortion decisions.

In more detail, intra-prediction involves the prediction of data spatially within a single picture, without a reference to other (temporally spaced) pictures. In other words, data for a first region of a picture is used in the prediction of the data for another region of the same picture, but there is no dependence on another temporally spaced picture. In this context, the data for the first region of the picture is considered a “reference sample”.

Inter-prediction involves the prediction of data between a plurality of temporally-spaced pictures. In other words, data for a first region of a first picture is used in the prediction of data for a second region of a second picture. The first and second region may or may not be spatially separated from one another. In this context, the data for the first region of the first picture is considered a “reference sample”. It is further noted that inter-prediction may sometimes use multiple reference regions from different pictures at once, i.e. for a single prediction operation.

A “residual” in the embodiments may refer to value obtained based on an original value of a region of a picture and a prediction value of the region of the picture (e.g. the difference between the original value and the predicted value).

A “block” in the embodiments may refer to a portion of a picture. For example, a picture may be portioned into two or more blocks. However, this only an example. If a picture is not partitioned, then a “block” can refer to the entire picture.

A “filter”in the embodiments may refer to a filter that acts to enhance a signal.

In general, in the described embodiments, the filter is configured to sharpen blurred content, reduce ringing artifacts, and/or reduce blocking artifacts. However, embodiments are not limited to this and the filter can instead be configured to provide alternative or additional enhancements in other embodiments.

The general optimization problem in video coding is to minimize the transmission rate and the distortions at the same time. A lower transmission rate leads to stronger and more visible distortions which reduce the perceived quality of the viewer. The errors caused by the encoding are not random but caused by the processing steps in the encoder and decoder. Two important steps of a video coding system are the prediction and transformation. The quantization of the transform coefficients induces the reconstruction errors. Many video coding systems employ a hybrid coding structure, where the content of a block is predicted by intra-or inter prediction. This prediction is usually not perfectly accurate. Consequently, the difference of the ground-truth signal is calculated, transformed and encoded to compensate for the prediction error. The signal after the addition of the residual is filtered by so-called in-loop filters.

The processing steps cause artifacts Ih are not random. Embodiments of the invention make use of prior information can be used to address specific types of errors.

Two useful applications are the reduction of ringing artifacts and the sharpening of edges. Those two problems can be hard to address with linear filters. The weighted filter of embodiments of the invention employs a straightforward concept to overcome the limitations of conventional linear filters. The idea is to apply two filters. The first extracts local information from the decoded picture. The second filter applies a filtering which depends on the output of the first filtering setup. In some embodiments, the second filter would be RD-optimized depending on the output of the first filter. With that, non-linear filters that are adaptive to certain picture features can be signaled.

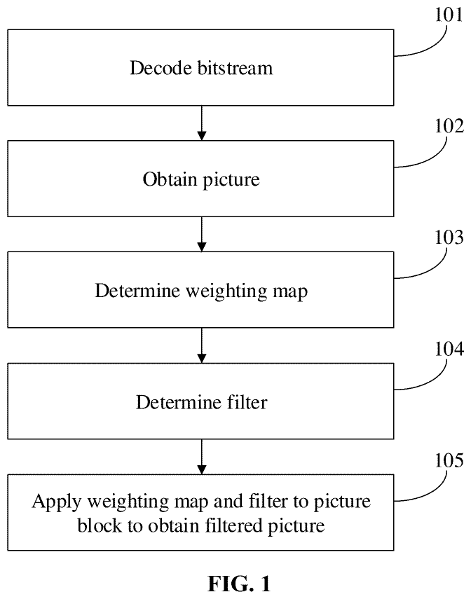

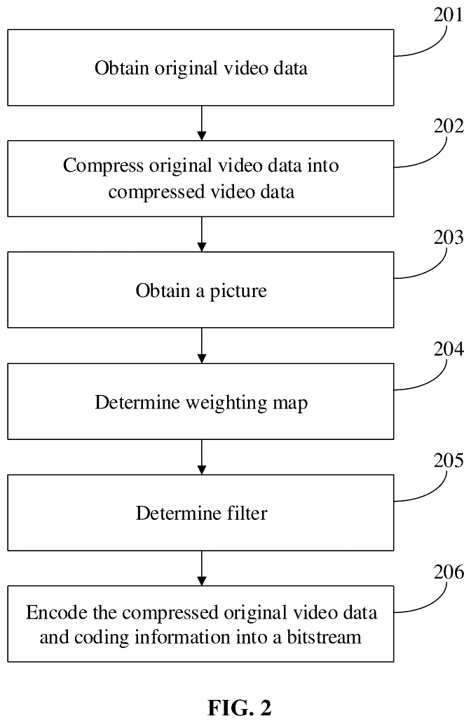

FIG. 1 shows a flowchart of the operations of a decoder 60 according to an embodiment. FIG. 2 shows a flowchart of the operations of an encoder 70 in accordance with this embodiment.

The flowchart of FIG. 1 starts a step 101, in which the decoder 60 decodes a bitstream to obtain video data and coding information. In this embodiment, the coding information includes weighting map information.

At step 102, the decoder 60 obtains (or “reconstructs”) a picture based on the video data. The video data comprises a compressed version of original video data. In this embodiment, step 102 involves obtaining the prediction block through an intra-prediction operation using the video data, as specified in H.266/VVC. However, embodiments are not limited in this respect and any other method of obtaining a picture from compressed video data can be used instead in other embodiments. Examples include inter-prediction as specified in H.266/VVC or intra-prediction or inter prediction as specified in H.265/HEVC.

At step 103, the decoder 60 determines a weighting map using the weighting map information. In this embodiment, the decoder 60 determines a weighting map using the weighting map information. In this embodiment, the weighting map information comprises a weighting map function to be used to calculate the weighting map.

One such example is that, when a sharpening filter is to be used, the weighting map information comprised in the coding information is a local gradient calculation function. In such an example, at step 103, the decoder 60 applies the gradient calculation function to calculate the gradient at each location in the picture, thereby arriving at a scalar weighting map having a same resolution as that of the obtained picture (with a value corresponding to each respect location in the picture). In other words, the picture is provided as an input to the weighting map function.

However, it will be appreciated that this is just one example. In other embodiments, the weighting map may have a different resolution to the picture and/or may comprise vector values rather than scalar values. Furthermore, it will be appreciated that the example of a picture gradient function is just an example, and that in practical implementations of embodiments, the choice of appropriate weighting map function will depend on the circumstances, particularly which filter is to be used. These factors and possible variants will be discussed in more detail later.

Furthermore, while it has been discussed in this embodiment that the coding information comprises weighting map information which comprises a weighting map function, embodiments are not limited in this respect. For example, in some embodiments a plurality of weighting map functions are stored at the decoder 60. In such cases, the weighting map information instead comprises an indication of which weighting map to use. Moreover, in some embodiments, the coding information does not comprise any explicit weighting map indication. Instead, for example, the coding information may comprise filter information, with the decoder 60 then inferring the weighting map function to be used (e.g. if the coding information indicates that a sharpening filter should be used, the decoder infers that a picture gradient function should be used as the weighting map function). These factors and possible variants will be discussed in more detail later.

At step 104, the decoder 60 determines a filter to be used. In this embodiment, the decoder 60 infers the filter to be used from the weighting map information. As discussed above, in one example, the weighting map information comprised in the coding information is a local gradient calculation function. In this example, the decoder 60 can infer that a (e.g. pre-stored) sharpening filter should be used in conjunction with the weighting map that comprises picture gradients.

At step 105, the decoder 60 applies the weighting map and filter to the picture to obtain a filtered picture. Hence, step 105 involves using the determined weighting map so that the filter is applied with different strengths to different regions of the picture.

In this embodiment, applying the weighting map and filter to the picture involves providing both the picture and weighting map as inputs to the filter. This results in the filter being applied with different strengths to each value of the picture, depending on the value of the respective weight in the weighting map. The output of the filter is a map of offset values. The map of offset values in this embodiment corresponds in resolution to the picture. Once the map of offset values is output, the offset values are then added to the values of the picture to result in an output (enhanced) picture.

In the above discussion, it is assumed that the filter is a sharpening filter configured to sharpen blurred edges. However, embodiments are not limited to this, and any suitable filter for enhancing the picture can be used instead.

Following step 105, the output picture can then be used for any desired purpose. In one example, the decoder 60 then displays the output picture to a viewer. In another example, the decoder 60 stores the picture for later use. In another example, the decoder 60 transmits the picture to an external device for display.

A complementary method can be performed by the encoder 70 in order to encode the bitstream provided to the decoder 60. FIG. 2 shows a flowchart of the operations of the encoder 70 according to this embodiment.

At step 201, the encoder 70 obtains original video data. For example, the encoder 70 may receive the original video data through a communication network (e.g. the internet) from an external server. However, there is no limit in the embodiments as to how the original video data is obtained.

At step 202, the encoder 70 compresses the original video data into a form to be transmitted to the decoder 60.

At step 203, the encoder 70 obtains a picture based on the compressed video data. In this embodiment, step 203 occurs in the same manner as step 102 of FIG. 1. In other words, in this embodiment, step 203 involves obtaining the prediction block through an intra-prediction operation using the compressed video data, as specified in H.265/HEVC. However, as mentioned above, embodiments are not limited in this respect and any other method of obtaining a picture from compressed video data can be used instead in other embodiments. Examples include inter-prediction as specified in H.265/HEVC or intra-prediction or inter prediction as specified in H.266/VVC.

At step 204, the encoder 70 determines a weighting map, while at step 205, the encoder 70 determines a filter to be used. In performing these steps, the encoder 70 determines a combination of weighting map and filter to be used to enhance the picture by applying the filter with different weights to different regions of the picture.

In order to determine a combination of weighting map and filter that enhances the picture, steps 204-205 may involve a rate distortion (RD) optimization process involving iteratively applying a plurality of filters with a plurality of weighting maps to the picture. For each application, an average difference in values between the resulting picture and a corresponding picture from the original video data is determined. This cycle continues until a stopping criterion is met (e.g. an optimum weighting map has been determined for a particular filter).

In other words, an RD-optimization process takes place at the encoder, based on estimated signaling rate and distortion of the obtained picture.

A first example of a suitable stopping criterion is that a particular weighting map results in an average absolute difference (or average squared difference) of values between the resulting picture and a corresponding picture from the original video data being less than a predetermined threshold difference. A second example of a suitable stopping criterion is that an average absolute difference (or average squared difference) of values between a weighting map of the current iteration of the iterative process and a weighting map of the previous iteration of the iterative process is less than a second predetermined threshold difference. The first example of a suitable stopping criterion directly measures the output quality and therefore can be assumed to result in higher ultimate picture quality than the second example. However, the second example ensures that the iterative process does not require excessive computation time. In some embodiments, both of these examples are used, and the iterative process stops when either one of these two stopping criteria is met.

In the example discussed above with regard to FIG. 1A, a single (sharpening) filter is used (with a corresponding weighting map). However, while this embodiment has been discussed with regard to finding a single combination of filter and weighting map, embodiments are not limited in this respect. For example, in some embodiments, the encoder may identify a plurality of combinations of weighting map and different types of filter to be used.

The method of FIG. 2 then continues to step 206, in which the encoder 70 encodes the compressed video data and coding information into a bitstream, the coding information comprising the weighting map information.

Through the methods discussed with reference to FIGS. 1 and 2, it can be seen that there is an in-loop filtering method which is applied inside the encoding loop of a video compression system. The in-loop weighted filter employs a function for calculating a local weighting/parameter map and a filtering function. The weighting map function makes use of the input picture and optionally coding information/signaled parameters to calculate the weighting map. The filtering function makes use of the input picture, weighting/parameter map, and optionally coding information/signaled parameters to calculate the filtered picture.

According to this method, by applying a filter with local weightings, it is possible to increase coding performance and allow for a wider range of applications. Through the use of a weighting function to determine a weighting map, a weighted filtering can be used with weights to guide the properties of a filter at each spatial location. For example, the strength of a sharpening filter can be increased at locations of a picture which are close to edges and decreased at regions which are further away from edges. With that, ringing artifacts and overshoot might be reduced while maintaining sharpening properties.

In some examples, the optimisation discussed with reference to steps 204-205 of FIG. 2 involves iterating between filter and weighting map function parameters. For example, starting parameters for a weighting map are set, and then the filter parameters are optimised based on the current weighting map. Then the weighting map parameters are optimised based on the found filter parameters and so on. In such cases, the coding information would comprise information on the weighting map function as well as the filter function (e.g. the parameters to be used). Of course, this is a basic form of optimization procedure. In some cases, additional side constraint can be set, for example in order to not only determine the best filter and weighting map in terms of picture quality but also to have the coding rate as low as possible. This can be achieved by introducing those conditions in both of those individual optimizations and selecting the starting point for the next iteration under consideration of rate costs as well. More generally, it is possible to additionally introduce simplifications that limit the computational costs.

In this embodiment, the weighting map provides linear weightings for the filter. However, embodiments are not limited to this, and in other embodiments, the values of the weighting map can instead modify the filtering procedure itself. For example, the filter could be parametric. For example, the frequency response of an edge enhancement filter could be dependent on the local weighting map parameter. For example, the sigma value in unsharp masking (one type of sharpening filter) could be dependent on the weighting parameter. That means that the way that the filter works or more specifically, the function of the filter is parametric and not necessarily linearly dependent of the weighting map. Another example is a filter that does an edge thinning (sharpening) by warping the picture. The strength of the warping could depend on the current weighting map value.

In this embodiment, the weighted filter is applied in-loop. However, embodiments are not limited to this particular order, and a weighted filter may be applied at other processing steps additionally or alternatively in other embodiments, such as post-loop.

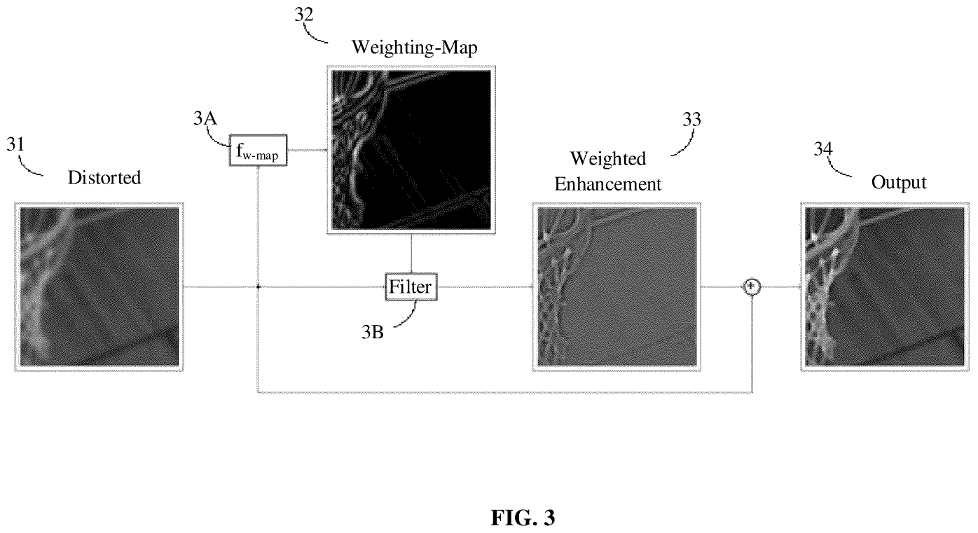

To illustrate the principles discussed above with reference to the embodiment of FIG. 1 and FIG. 2, an illustrative example will now be discussed with reference to FIG. 3.

FIG. 3 shows a block diagram illustrating example operations according to the embodiment of FIG. 1 and FIG. 2 discussed above. In other words, FIG. 3 shows a conceptual diagram of how the weighted filter could be implemented.

As can be seen in the process of FIG. 3, a distorted picture 31 is eventually turned into an (enhanced) output picture 34.

The distorted picture corresponds to the obtained picture discussed with reference to, for example, step 102 of FIG. 1.

With reference to step 103 of FIG. 1, for example, this distorted picture is then provided as input to the weighting map function (f_{w-map}) 3A that has been determined based on the coding information to result in the weighting map 32. In this particular example, as discussed above, the weighting map function 3A is a local gradient calculation function. As such, the weighting map 32 comprises a plurality of values of the picture gradient at each spatial location in the distorted picture 31.

With reference to step 104 of FIG. 1, the filter 3B is determined. As discussed above, in this embodiment, the decoder 60 infers the filter to be used from the weighting map information. As also mentioned above, in this example, the weighting map information comprised in the coding information is a local gradient calculation function. Hence, in this example, the decoder 60 infers that a (e.g. pre-stored) sharpening filter should be used in conjunction with the weighting map that comprises picture gradients.

With reference to step 105 of FIG. 1, the decoder 60 then applies the weighting map 32 and filter 3B to the distorted picture 31 in order to obtain the output picture 34. As can be seen in FIG. 3, this step involves provided the distorted picture 31 and weighting map 32 as inputs to the (sharpening) filter 3B, which thereby results in a weighted enhancement map 33. This weighted enhancement map 33 comprises a plurality of offset values respectively spatially corresponding to values of the distorted picture 31.

Next (as a part of step 105 of FIG. 1), the decoder 60 adds the offset values from the weighted enhancement map 33 to the respective values of the distorted picture 31 in order to arrive at the output picture 34.

Through this method, it can be seen that the blurring has been reduced without any significant issues regarding ringing artifacts and overshoot that can be caused by sharpening filters. This has been achieved through the local weighting of the sharpening filter, ensuring that it is not merely uniformly applied to the entire picture, but instead applied at different strengths to different spatial parts of the picture, depending on the properties of those spatial parts.

In more detail, the strength of the sharpening filter has been increased at locations of the picture which are close to edges and decreased at regions which are further away from edges. With that, ringing artifacts and overshoot are reduced while maintaining sharpening properties.

Note that in some embodiments, the addition of the offset map is incorporated into the filter function. However, for the purpose of better visualization, those operations are shown as separate steps in FIG. 3.

Furthermore, as will be discussed in more detail later, in some embodiments, both (or either of) the weighting map and the filtering function can be parametric functions which depend on parameters signaled in the bitstream.

It can be seen that the weighted filter comprises two main components. The weighting-/parameter-map calculation function and a (possibly parametric) filter.

First, the weighting map is calculated. In this embodiment, the weighting map may is calculated at every point of the picture (though in other embodiments, it can be calculated at lower resolution). Next, the filter is applied. Thereby, the weighting-/parameter-map and the decoded picture are input to the filter. With that, the filtered picture is generated.

In the embodiment of FIGS. 1 and 2, the method is applied to the luma channel. However, embodiments are not limited in this respect. In other embodiments the method is applied to only a chroma channel, or to both a luma channel and a chroma channel. In other words, in some embodiments, both (or either) of the weighting-/parameter-map calculation function and the filter may be different for different channels. Hence, separate information/parameters may be signaled for luma and chroma components.

In this embodiment, the weighted filter replaces both the SAO and ALF of the VVC/H.266 system.

However, embodiments are not limited in this respect. For example, in other embodiments, the weighted filter replaces only one of SAO or ALF, or is provided in addition to the SAO and ALF. In another example, the weighted filter can be integrated into the ALF such that each of the partitions of the picture can be either filtered by an optimized linear filter or by the weighted filter. With that, the ALF would gain additional flexibility. For maximum flexibility, the filter may be added at any point in the chain of in-loop filters.

While these specific examples have been discussed, it will be appreciated that embodiments are not limited to the H.266/VVC scheme in this way. In other embodiments, the weighted filter is applied in a different coding scheme altogether (e.g. H.265/HEVC or any other suitable coding scheme).

Furthermore, in other embodiments, the weighted filter is applied as a post-filter to enhance the quality of coded videos. This can be beneficial if the back-coupling (from in-loop filtering) would lead to worse predictions of subsequent pictures. In such cases, an out of loop/post-filtering would be beneficial. Such determinations can be made by the encoder when performing encoding, in embodiments.

Hence, more generally, in embodiments the weighted filter can be integrated into the coding loop as an additional processing step of existing schemes, as alternative to an already existing loop filter or integrated into an already existing loop filter.

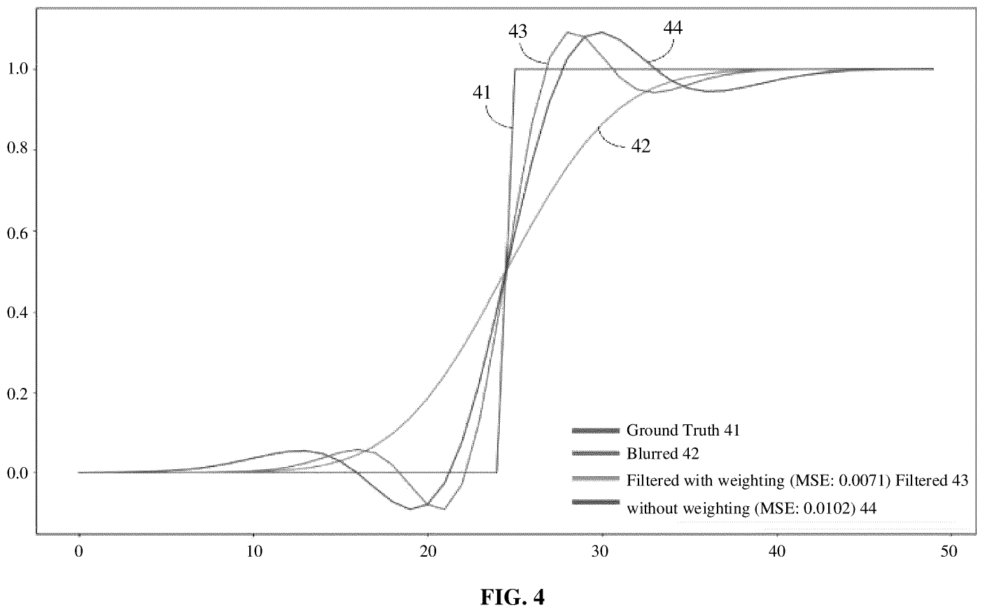

To further explain the concept of the weighted filter discussed above, another example implementation with now be discussed with reference to FIG. 4. FIG. 4 shows graph comparing a plurality of filtering schemes against a ground truth signal.

Let there be a blurred edge x as input of a filter. A ground truth signal 41 (shown in FIG. 4) is a step function. For simplicity and ease of visualization, a one-dimensional signal is shown. Note that this is done only to explain the concept in a simple way. In general, the methods discussed herein may be applied to signals of arbitrary dimension.

The graph of FIG. 4 shows four lines. There is the ground truth signal 41, a blurred signal 42 (e.g. corresponding to the distorted 31 of FIG. 3), a weighted filtered signal 43 (e.g. corresponding to the output picture 34 of FIG. 3), and a non-weighted filtered signal 44 (e.g. corresponding to the output picture 34 of FIG. 3 if the weighting map had not been used i.e. if only the filter was used).

In the non-weighted filtering the blurred signal 42 is filtered by a least-squares optimized linear filter in order to approximate the original signal as precisely as possible, thereby arriving at the non-weighted filtered signal 44. It can be seen in FIG. 4 that this type of filtering does increase the steepness of the edge to thereby provide a better approximation of the ground truth signal 41, but causing an overshoot and ringing which is non-optimal.

A better result is achieved if the high-pass characteristic of the filter is stronger at the steepest part of the edge and less strong at the region where ringing and overshoot artifacts are caused by the filter. To achieve this, in the weighted signal 42, the offset of the filtered blurred edge compared to the blurred edge is scaled by a larger factor at the predicted location of the edge and scaled by a small factor if there are overshoot or ringing artifacts expected. For that, a local weighting is calculated from the picture (i.e. the weighting map is calculated). For example, (and as discussed above with regard to FIGS. 1 to 3), the magnitude of the gradient approximated by finite differences can be used. For optimal results, the filter would then be optimized considering the local weighting.

As shown in FIG. 4, the weighted filtered signal 43 has a smaller error compared to the non-weighted filtered signal 44, relative to the ground truth signal 41. Moreover, in this example it can be seen that the overshoot is at a similar level for the weighted filtered signal 43, but the steepness of the signal and the ringing is not as severe (i.e. it has similar amplitude but it flattens out earlier).

From this example it can be seen that local adaptivity is beneficial to increase the performance of a filter if the characteristics of the signal and error are known. The adaptive loop filter (ALF) approaches this by applying different filters depending on the picture characteristics. This allows for more flexibility, but at the cost of increased bitrate.

Embodiments of the present invention make use of weighted (possibly parametric) filters to reduce the need for the use of many different filters. The shown example is one application case, where a single weighted filter might replace a set of filters while achieving similar results. This is particularly applicable where there are dependencies which can be exploited by a local parametrization.

In this embodiment, it has been discussed that the coding information comprises weighting map information which comprises a weighting map function. However, embodiments are not limited in this respect. For example, as discussed above, in some embodiments a plurality of weighting map functions are stored at the decoder 60. In such cases, the weighting map information instead comprises an indication of which weighting map to use. Moreover, in some embodiments, the coding information does not comprise any explicit weighting map indication. Instead, for example, the coding information may comprise filter information, with the decoder 60 then inferring the weighting map function to be used (e.g. if the coding information indicates that a sharpening filter should be used, the decoder infers that a picture gradient function should be used as the weighting map function).

In the embodiment discussed above with reference to FIGS. 1 and 2, the weighted filter is applied in an in-loop manner, specifically within the VVC/H.266 system.

Generally, in-loop filters may be applied at every point inside the coding loop. However, the order of application can have an impact on the overall performance since most loop filters are non-linear. One example of a video coding system is VVC/H.266. In this system, there are four in-loop filters which are applied sequentially. Those are luma mapping with chroma scaling (LMCS), de-blocking, sample adaptive offset (SAO) and the adaptive loop filter (ALF). The LMCS addresses very different errors than the proposed filter and inverse mapping should be applied before the proposed filter to avoid artifacts. Moreover, it makes sense to apply the de-blocking filter before the proposed method.

While particular implementations of the invention have been discussed above, a number of variations can be made in other embodiments, which will now be discussed, particularly with regard to the choice of weighting map function, the filtering function, region partitioning and the signaling.

As is apparent from the above discussion, the weighting map provides one or more weights/parameters to the filter. In other words, the filter is a parametrical function with the weighting map and the picture (and possibly coding parameters) as input.

Regarding the weighting map, in the embodiment of FIGS. 1 and 2, the weighting map is a scalar map. In this scalar map, each spatial location has exactly one value assigned to it. However, in other embodiments, the weighting map is a multi-dimensional map. In such embodiments, there is a vector of values at each spatial location. reviohould also be noted that, in embodiments of the invention, the spatial size of the weighting map is not restricted to the resolution of the picture. Depending on the requirements, in some embodiments it might be of smaller resolution to reduce computational complexity. The optimal choice of weighting map function heavily depends on the type of errors that are addressed by the filter and the type of filter that is applied to deal with those errors.

As discussed above, in the embodiment of FIGS. 1 and 2, applying the weighting map and filter to the picture (step 105 in FIG. 1) involves providing both the picture and weighting map as inputs to the filter. This results in the filter being applied with different strengths to each value of the picture, depending on the value of the respective weight in the weighting map. The output of the filter is a map of offset values, and the map of offset values corresponds in resolution to the picture. Once the map of offset values is output, the offset values are then added to the values of the picture to result in an output (enhanced) picture. An example of this is shown in FIG. 3, for example, which has been discussed above.

However, embodiments are not limited to this particular implementation. In an alternative, simple implementation, the strength values (i.e. weights of the weighting map) are used by the filter to scale the offset which is generated by the filter. This is done by multiplying the strength value (i.e. weight) by the difference between the output of the filter and the obtained picture. Adding this scaled difference to the obtained picture then changes the offsets generated by the filter depending on the computed weights. Consequently, the effect of the applied filter is different depending on the spatial location.

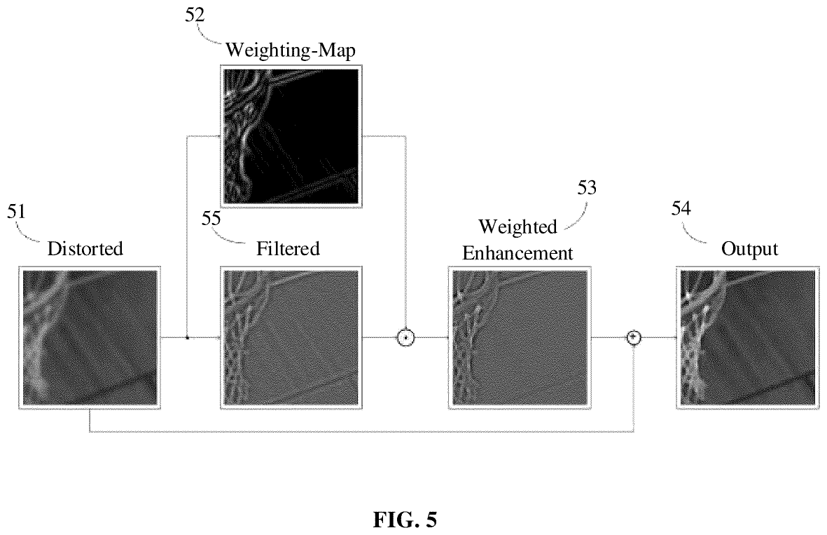

An example of this setup is shown in FIG. 5, which shows a block diagram illustrating example operations of this alternative method.

It can be seen that the method of FIG. 5 involves the distorted picture 51 being provided as an input to the weighting map and, separately, being provided as an input to the filter. The strength values (i.e. weights) of the resulting weighting map 52 are then multiplied by the difference between the output of the filter 55 and the distorted picture 51. Adding this scaled difference to the distorted picture 51 then changes the offsets generated by the filter depending on the computed weights.

In other words, a scalar weighting is computed to weight the output of the filter by sample-wise multiplication. The computed offset is added to the input picture to get the output.

From a comparison with the example of FIG. 3, it can be seen that, rather than the weighting map 52 being applied as an input to the filter, its values are instead simply multiplied by an output from the filter (specifically the difference between the output of the filter 55 and the distorted picture 51).

In some embodiments, the weighting map function is an edge detector which assigns higher weights to locations which are on an edge and lower values around edges and in flat regions. Hence, in such embodiments, the resulting weighting map is a scalar. With that, an edge sharpening with less artifacts could be achieved. In such embodiments, the encoder could encode information identifying the edge detector function in the bitstream, for example.

In other embodiments, the weighting map function is a detector for ringing artifacts. This would, for example, assign a probability that there is ringing at a given location. Hence, in such embodiments, the resulting weighting map is a scalar. Through application of this weighting map, the filter strength would then be set based on this probability. In such embodiments, the filter could, for example, be a simple linear low-pass filter. However, in many cases, ringing is close to edges which should, ideally, be preserved. Therefore, the filtering solution should, ideally, preserve edges. One example for a filter that is suitable for that would be a bilateral filter. Parameters could be optimized at the encoder and transmitted in the bitstream in embodiments making use of such filters.

Furthermore, in some embodiments, these two options of weighting maps can be combined into a two-dimensional weighting map or they can both be applied sequentially. Combining them gives more flexibility with regards to the filtering. Knowing about the estimated probability of ringing and the presence of edges helps the encoder to find the optimal filtering in its rate distortion optimisation process (e.g. steps 204-205 of FIG. 2). For example, an edge amplification should be applied more carefully, if ringing is very close to this position as this may be amplified, which can be optimised by the encoder in the encoding process.

reviousvious example of applying a bilateral filter also shows an example of how a multi-dimensional weighting map could be applied in some embodiments, rather than just a scalar). For example, in some embodiments, the encoder determines different parameters if there is a large contrast area compared to areas with small contrast. In this case, the parameters of the bilateral filter are estimated from the obtained picture and signaled to the decoder.

Another application in other embodiments is to estimate parameters of the edge sharpening filter from the picture. For example, if the weighting map estimates whether there is very sharp content like text at a certain location in the picture, a different sharpening can be applied compared to other types of content. Note that in such embodiments, the weighting map can be derived from the picture content, coding information or signaled parameters. In these embodiments, the weighting map can be one-dimensional. The weighting map can be binary, integer or floating-point. In these embodiments, the weighting map may alternatively be multi-dimensional, with each element being binary, integer or floating-point. The data type of each element of the weighting map depends on the requirements of the filtering system.

In some embodiments, the weighting map calculation parameters are signaled in in the bitstream and decide on the type of weighting map function. In other embodiments, the signaled weighting map calculation parameters are parameters to the function itself. For example, an edge map could have a steepness scaling parameter which decides how much the weighting is increased based on the steepness. Note that this might be a non-linear scaling. For example, a scaling by taking the n-th power of the value could be used.

In some embodiments, a set of, (possibly parametric) weighting map functions are pre-defined. As such, the bitstream signals only the used weighting map function(s)/weighting map(s) (and possibly particular parameters to be used in these weighting map functions) rather than the entire weighting map function.

In summary regarding the weighting map, in some embodiments, a weighting map function is applied which outputs a scalar weighting map, with the scalar being binary, integer or floating-point. In other embodiments, a weighting map function is applied which outputs a multi-dimensional weighting map, with each element being binary, integer or floating-point. In these embodiments, the weighting map information for one or more channels of the obtained picture is computed while using the information from one or more channels of the reconstructed picture as input. In some embodiments, a set of, (possibly parametric) weighting map functions are pre-defined, with the bitstream signalling the used weighting map function(s)/weighting map(s).

Regarding the filter, the filter function(s) used in some embodiments of the invention is generally a multi-dimensional parametric function which takes the weighting map, filter parameters, one or more channels of the obtained picture and possibly coding information as input. The output is one or more (weighted) filtered channels of the obtained picture.

While the embodiments have generally been discussed with regard to the application of a single filter, the invention is not limited in this respect. For example, in other embodiments, a series of filters with different parameters and potentially different weighting maps may be applied. Depending on the type of artifacts, complexity requirements and RD-decision, different filtering functions may be most suitable.

For example, in some embodiments, a linear weighted filter may be used. In such embodiments, this filter can be weighted by multiplying the output of the filter by the local weighting and then adding the result to the obtained picture. The advantage of such a system would be that the optimal parameters could be found by a least-squares optimization. Consequently, there is no parameter search required to find the optimal solution.

However, in such embodiments, the linear filter would require, depending on the characteristics of the picture, a relatively large number of filter coefficients (which would need to be transmitted). To counteract that, in some embodiments, a parametric description of the filter is used to decrease the coding costs (though this is at the cost of reduced flexibility).

An example of a parametric description is to model a high-pass filter as Difference of Gaussian filter. Then, only the sigma values need to be transmitted instead of the whole set of filter coefficients. This approach is useful if the frequency response of the parametric filter is close enough to the distribution of filters which would be obtained by least squares optimization. However, depending on the side constraints of the parametric representation n, a closed form solution might not be found, in which case an iterative optimization would be required.

Another type of filter that can be used in another embodiments is a (parametric) non-linear filter. Examples include bilateral filters, median filters, or other filters. The parameters of those filters can be signaled in the bitstream or given by the weighting map. Note that switching the type of filtering function based on weighting map parameters is also an option.

In other words, in some embodiments, the value of the weighting map at a particular scalar location can indicate the type of filtering function to be used at that spatial location of the picture.

In summary regarding the filter, in some embodiments, one or more filters can be applied for each signaled weighting map. The filtering function and the parameters of the filter may be signaled in the bitstream, pre-defined or inferred from the content of the video sequence or coding information. In some embodiments, a linear filter is applied as the filter in the filtering function. The shape of the filter may be indicated in the bitstream or pre-defined. In some embodiments, the linear filter is optimized by a least-squares optimization or RD-optimized. In some embodiments, a parametric linear filter is used, where the parameters can be used to generate the corresponding linear filter. In some embodiments, the parametric linear filter is RD-optimized with regards to a minimal error at the output or RD-optimized. The optimum filter may be derived by least squares optimization, iterative search, or exhaustive search. In some embodiments, a parametric or non-parametric non-linear filter is applied in the filtering function. In some embodiments, a bilateral filter in the filtering function. In some embodiments, a combination of the discussed filtering methods is applied, where the used filtering method at each location is signaled or indicated by the weighting map. In some embodiments, the encoder optimizes a parametric weighting map together with the filtering function.

In the embodiments described herein, the weighted filter has been described as being applied to the whole picture. However, embodiments are not limited in this respect. In variants of these embodiments, there may be different filtering setups for different partitions of the picture. Furthermore, an overlapping application of filters is possible. Two example implementations for region partitioning will now be discussed.

The first is a block-wise partitioning of the picture, with each filter being applied to one or more blocks. An alignment to coding tree unit (CTU) and coding (CU) boundaries may be considered in some embodiments. The applicable picture partitioning would then be signaled in the bitstream.

The second is to partition the picture based on picture characteristics. In some embodiments this partitioning can derived at the decoder side as well as on the encoder side without the need for signaling in the bitstream. This could be implemented as a binarized or non-binary weighting map. Each resulting partition can then be handled individually, or partitions are handled in groups in embodiments.

When region partitioning is used, the filters to be applied to one partition or partition group can be optimized at the encoder side and the parameters can then be signaled in the bitstream.

Hence, in some embodiments, a picture can be split into multiple partitions. The partitions may be defined by a signaled block-partitioning, signaled region partitioning criteria and/or by a binarized weighting map function. Furthermore, in some embodiments, multiple filters can be applied to the same picture partition.

The use of partitions in these ways can be useful particularly when dealing with larger or very diverse pictures. For such pictures, very different types of content might be present, and the error characteristics might be very different at different partitions of the picture. Consequently, optimizing two or more filters for different partitions of the picture might lead to superior performance.

As discussed in the described embodiments, coding information can be included in the bitstream, for example regarding the weighting map function and/or filter to be applied for the picture. More generally, in embodiments, the coding information can comprise (but is not restricted to) filter coefficients, weighting map function parameters, on-/off-flags, filter encoding parameters or region parameters etc.

In some embodiments, this information (e.g. all the parameters) is encoded and signaled so as to reduce the transmission rate and increase the efficiency of the overall filtering process. This is done by exploiting redundancies with regards to the transmitted parameters. Those redundancies are exploited by prediction and entropy coding on filter parameters. Moreover, in some embodiments, parameters are quantized to reduce the number of possible representations.

In the embodiments described herein, the filter that is used (i.e. the sharpening filter) is based on the concept of a Wiener filter. In other embodiments, the filter is a linear filter that has been optimized at the encoder by a least-squares optimization procedure (i.e. a linear filter that minimizes the squared error between the filtered signal and the ground-truth signal). Of course, in some embodiments, additional side constraints are set in the determination of the signal enhancement filter, such as the filter shape, and filter coefficients that have to be equal.

However, while the embodiments have been discussed with reference to a filter based on the concept of a Wiener filter, embodiments are not limited in this respect, and other types of filter could be used instead, such as a filter based on a Sobel-filter or unsharp masking filter as sharpening filters. Other non-linear options include bilateral filters and diffusion filters, as well as an Adaptive Loop Filter (ALF).

For example, in some embodiments, the weighted filter can be integrated into the adaptive loop filter (ALF) of existing coding schemes (e.g. H.265/HEVC and H.266/VVC) and applied to partitions derived by the ALF optimization as an alternative to linear filters.

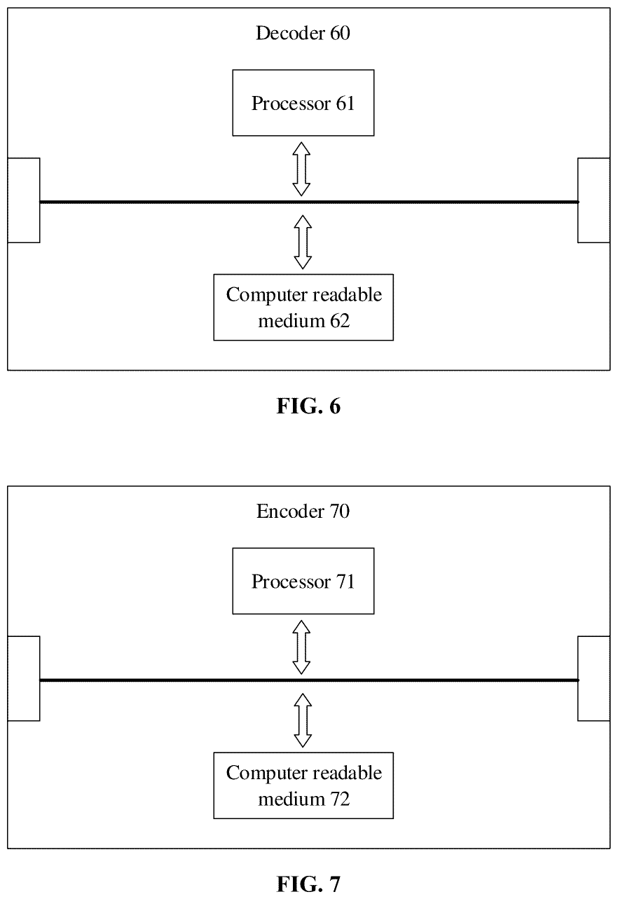

FIG. 6 shows a schematic illustration of a decoder 60 according to an embodiment. Specifically, FIG. 6 shows a schematic illustration of a decoder 60 configured to perform any of the decoder methods discussed herein. Such detailed descriptions thereof are omitted here for brevity.

As shown in FIG. 6, the decoder 60 comprises a processor 61 and a computer readable medium 62. The processor 61 and the computer readable medium 62 may be connected via a bus system. The computer readable medium is configured to store programs, instructions or codes. The processor 61 is configured to execute the programs, the instructions or the codes in the computer readable medium 62 so as to complete the operations in the decoder method embodiments herein.

Hence, in embodiments, the computer readable medium 62 is configured to store a computer program capable of being run in the processor 61, and the processor 61 is configured to run the computer program to perform steps in any of the decoder methods discussed herein.

FIG. 7 shows a schematic illustration of an encoder 70 according to an embodiment. Specifically, FIG. 7 shows a schematic illustration of an encoder 70 configured to perform any of the encoder methods discussed herein. Such detailed descriptions thereof are omitted here for brevity.

As shown in FIG. 7, the encoder 70 comprises a processor 71 and a computer readable medium 72. The processor 71 and the computer readable medium 72 may be connected via a bus system. The computer readable medium is configured to store programs, instructions or codes. The processor 71 is configured to execute the programs, the instructions or the codes in the computer readable medium 72 so as to complete the operations in the decoder method embodiments herein.

Hence, in embodiments, the computer readable medium 72 is configured to store a computer program capable of being run in the processor 71, and the processor 71 is configured to run the computer program to perform steps in any of the decoder methods discussed herein.

As discussed, in embodiments, the weighted filter is a parametric filter. Depending on the implementation it is also content-adaptive in some embodiments. The two main objectives of the filters discussed in the embodiments are the sharpening of blurred content and the reduction of ringing artifacts. However, other objectives for the filtering process are possible, such as to reduce blocking artifacts.

In some embodiments, the weighted filter is a local adaptive filter. Therefore, it can be used to deal with non-linear filtering problems. Two useful applications would be the reduction of ringing artifacts and the sharpening of edges. Those two problems can be hard to address with linear filters. The weighted filter of embodiments of the invention employs a straightforward concept to overcome the limitations of conventional linear filters. The idea is to apply two filters. The first extracts local information from the decoded picture. The second filter applies a filtering which depends on the output of the first filtering setup. In some embodiments, the second filter is RD-optimized depending on the output of the first filter. With that, non-linear filters that are adaptive to certain picture features can be signaled.

In order to put the features of embodiments of the invention into further context, a discussion will now be provided regarding the weighted filtering of these embodiments relative to existing in-loop filters.

In-loop filtering is part of modern video coding systems. Usually, a set of different filters is applied sequentially. Those filters may be parametric, i.e. a set of filter parameters is sent that change the behavior depending on RD-decisions. They may also be non-parametric. Moreover, the filter may be content adaptive (i.e. the filter can have a different behavior depending on the spatial location in the picture). Sample adaptive offset (SAO) filters and adaptive loop filters (ALF) perform local classification of the content and apply different operations depending on the class. Usually, the classification operation to be applied is signaled.

In detail, the in-loop ALF method optimizes a set of linear filters. Each linear filter is applied to a partition of the picture. The partitioning is derived by local properties of the picture. Moreover, partitions might be merged. Such information is signaled in the bitstream. In embodiments of the invention, however, a locally weighted/parametrized filter is applied. As such, the need for picture partitioning and the optimization of multiple filters is reduced, thereby increasing coding efficiency.

In SAO, each sample (or ‘pixel’) is assigned to one class depending on local characteristics of the picture. For each class, an (intensity) offset is computed and signaled at the encoder. Hence, a class decision is done and for each class, a different operation is done. In embodiments of the invention, however, a locally weighted/parametrized filter is applied. As such, the need for picture partitioning and the optimization of multiple filters is reduced, thereby increasing coding efficiency.

As discussed, embodiments provide methods and devices to code parameters for an in-loop (or post-loop) filtering scheme. Thereby, the demands of a transmission in an adaption parameter set and the characteristics of coding information can be considered to allow for an efficient encoding. Embodiments employ a weighted/parametric filtering. The weighting/local parameters are calculated from a decoded video picture (e.g. a picture block). In some embodiments, the calculation functions may be parametric and/or signaled by the encoder.

In the following, we call the local parametrized weights the “weighting-map”.

While the term “weighting map” has been used, this term is used for readability purposes and is not meant in a restrictive way. For example, in some embodiments the weighting map might contain local parameters or a vector containing parameters and weighting values at the same time. In addition to the calculation of the weighting, a filter is applied. In some embodiment, this filter may be parametric with regards to the weighting map, or it may be locally weighted according to the weighting map.

As discussed, embodiments provide an in-loop filtering method which can be applied inside the encoding loop of a video compression system. The in-loop filter employs a function for calculating a local parameter map and a filtering function. The weighting map function may use the input picture, coding information and/or signaled parameters to calculate the weighting map. The filtering function may use the input picture, coding information, signaled parameters and/or the parameter map to calculate the filtered picture.

In some embodiments, the method is integrated into a coding loop as an additional processing step, as alternative to an already existing loop filter or integrated into an already existing loop filter.

In some embodiments, the method is RD-optimized based on estimated signaling rate and distortion after applying the method.

In some embodiments, the method is applied to the luma-channel, the chroma channel or both. The processed channels may be set in advance, signaled in the bitstream or inferred from the content.

In some embodiments, the method is applied to one or multiple partitions of the picture. The partitions may be defined by a signaled block-partitioning, potentially signaled region partitioning criteria or by a binarized weighting map function.

In some embodiments, multiple filters are applied to the same picture partition.

In some embodiments, the method is used to address the problem of ringing artifacts, blurring or blocking artifacts.

In some embodiments, the method involves applying a weighting map function which outputs a scalar weighting map, with the scalar being binary, integer or floating-point.

In some embodiments, the method involves applying a weighting map function which outputs an n-dimensional weighting map, with each element being binary, integer or floating-point.

In some embodiments, the weighting map information is computed for one or more channels of the reconstructed picture while using the information from one or more channels of the reconstructed picture as input.

In some embodiments set of, possibly parametric weighting map functions are predefined, and the encoder signals the used weighting maps and weighting map functions.

In some embodiments, one or more filters are applied for each signaled weighting map. The filtering function and the parameters of the filter may be signaled in the bitstream, pre-defined or inferred from the content of the video sequence or coding information.

In some embodiments, the method involves applying a linear filter as the filter in the filtering function. The shape of the filter may be indicated in the bitstream or pre-defined.

In some embodiments, the linear filter is optimized by a least-squares optimization or RD-optimized.

In some embodiments, a parametric linear filter is applied. The parameters can be used to generate the corresponding linear filter.

In some embodiments, the parametric linear filter is RD-optimized with regards to a minimal error at the output or RD-optimized. The optimum filter may be derived by least squares optimization, iterative search, or exhaustive search.

In some embodiments, a parametric or non-parametric non-linear filter is applied in the filtering function.

In some embodiments, a bilateral filter is applied in the filtering function.

In some embodiments, a combination of the described filtering methods are applied, where the used filtering method at each location is signaled or indicated by the weighting map.

In some embodiments, the encoder optimizes a parametric weighting map together with the filtering function.

In some embodiments, one or more filters are applied to partitions of the picture based on a signaled block-partitioning.

In some embodiments, one or more filters are applied to partitions of the picture based on derived region partitioning criteria.

In some embodiments, the weighted filter is integrated the adaptive loop filter (ALF) and is applied to partitions derived by the ALF optimization as an alternative to linear filters.

In some embodiments, the encoder encodes the filter and weighting map calculation parameters by a quantization, prediction, or entropy coding scheme.

In some embodiments, the weighted filter is applied as a post-filter.

Embodiments of the invention can also provide a computer-readable medium having computer-executable instructions to cause one or more processors of a computing device to carry out the method of any of the embodiments of the invention.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

Applying a filter with local weighting increases coding performance and allows for a wider range of applications. Through the use of a weighting function to determine a weighting map, a weighted filtering can be used with weights to guide the properties of a filter at each spatial location. For example, the strength of a sharpening filter could be increased at locations of a picture which are close to edges and decreased at regions which are further away from edges. With that, ringing artifacts and overshoot might be reduced while maintaining sharpening properties.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present invention, and that various modifications can be made without departing from the scope of the invention. The scope of the invention should is to be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the invention, that being determined by the appended claims.

1. A method of processing video data, performed by a decoder, the method comprising:
decoding a bitstream to obtain video data and coding information;
obtaining a picture based on the video data;
determining a weighting map using a weighting map function, the weighting map comprising a plurality of weights mapped to respective spatial locations of the picture, wherein at least one of the picture or coding information are used as inputs to the weighing map function;
determining a filter to be applied with the weighting map; and
applying the weighting map and the filter to the picture to obtain a filtered picture, such that the filter is applied with different weights to different spatial locations of the picture.

2. The method of claim 1, wherein the coding information comprises signalled weighting map function parameters, and
wherein determining the weighting map using the weighting map function comprises:
applying the signalled weighting map function parameters as parameters of the weighting map function; and
providing the picture as an input to the weighting map function.

3. The method of claim 1, wherein the coding information comprises signalled filter function parameters, and
wherein determining the filter comprises:
applying the signalled filter function parameters as parameters of the filter.

4. The method of claim 1, wherein applying the weighting map and the filter to the picture to obtain the filtered picture takes place within the coding loop or as a post-loop step.

5. The method of claim 4, wherein the coding loop is a H.266/VVC coding loop.

6. The method of claim 4, wherein the step of applying the weighting map and the filter to the picture to obtain the filtered picture is integrated into an adaptive loop filter and is applied to derived partitions.

7. The method of claim 1, wherein the bitstream is rate distortion (RD)-optimized based on an estimated signaling rate and distortion after applying the weighting map and the filter to the picture.

8. The method of claim 1, wherein the picture comprises a luma-channel, a chroma channel or both, and
wherein the weighting map and the filter are applied to the luma-channel, the chroma channel or both.

9. The method of claim 8, wherein which of the luma-channel and the chroma channel the weighting map and the filter are to be applied to is predetermined, signaled in the bitstream, or inferred from the picture's content.

10. The method of claim 1, further comprising partitioning in the picture into a plurality of partitions,
wherein the weighting map and the filter are applied to one or multiple partitions of the picture,
wherein the partitions are signaled in the coding information.

11. The method of claim 10, wherein the partitions being signaled in the coding information comprises a signaled block-partitioning, signaled region partitioning criteria or a binarized weighting map function in the coding information.

12. The method of claim 10, further comprising applying multiple filters to a same picture partition.

13. The method of claim 1, wherein the filter is configured to address the problem of at least one of ringing artifacts, blurring or blocking artifacts in the picture.

14. The method of claim 1, wherein determining the weighting map using a weighting map function comprises:
applying a weighting map function which outputs a scalar weighting map, with the scalar being binary, integer or floating-point.

15. The method of claim 1, wherein determining the weighting map using a weighting map function comprises:
applying a weighting map function which outputs a multi-dimensional weighting map, with each element being binary, integer or floating-point.

16. The method of claim 1, wherein the weighting map information for one or more channels of the obtained picture is computed using information from one or more channels of the obtained picture as input.

17. The method of claim 1, wherein a set of weighting map functions are predefined, and wherein the coding information signals the weighting map function to be used.

18. The method of claim 17, wherein the weighting map functions are parametric.

19. A method of processing video data, performed by an encoder, the method comprising:
obtaining original video data;
compressing the original video data into compressed video data;
obtaining a picture based on the compressed video data;
determining a weighting map using a weighting map function, the weighting map comprising a plurality of weights mapped to respective spatial locations of the picture, wherein the picture is used as an input to the weighing map function;
determining a filter to be applied to the picture with the weighting map, wherein the filter is configured to be applied, with the weighting map, to the picture to obtain a filtered picture, such that the filter is applied with different weights to different spatial locations of the picture, at the decoder; and
encoding the compressed video data and coding information into a bitstream, the coding information comprising information on at least one of the weighting map function or filter to be used at a decoder.

20. A non-transitory computer-readable storage medium, having a computer program and a bitstream stored thereon, wherein the computer program, when executed by a processor, enables the processor to perform the following operations to generate the bitstream:
obtaining original video data;
compressing the original video data into compressed video data;
obtaining a picture based on the compressed video data;
determining a weighting map using a weighting map function, the weighting map comprising a plurality of weights mapped to respective spatial locations of the picture, wherein the picture is used as an input to the weighing map function;
determining a filter to be applied to the picture with the weighting map, wherein the filter is configured to be applied, with the weighting map, to the picture to obtain a filtered picture, such that the filter is applied with different weights to different spatial locations of the picture, at the decoder; and
encoding the compressed video data and coding information into the bitstream, the coding information comprising information on at least one of the weighting map function or filter to be used at a decoder.
